(19) United States
(12) Patent Application Publication
(10) Pub. No.: US 2016/0121435 A1
(43) Pub. Date: May 5, 2016

(54) METAL PASTE FOR JOINING, JOINING METHOD AND JOINED BODY

(71) Applicants: Masashi FURUKAWA, Toyota-shi, Aichi-ken (JP); Hiroomi KOBAYASHI, Toyota-shi, Aichi-ken (JP); Yoshinori SHIBATA, Toyota-shi, Aichi-ken (JP); Keisuke UCHIDA, Toyota-shi, Aichi-ken (JP); Hiromasa MIYOSHI, Chiyoda-ku, Tokyo (JP); Keiichi ENDOH, Chiyoda-ku, Tokyo (JP); Satoru KURITA, Chiyoda-ku, Tokyo (JP); Minami NAGAOKA, Chiyoda-ku, Tokyo (JP)

(72) Inventors: Masashi FURUKAWA, Toyota-shi, Aichi-ken (JP); Hiroomi KOBAYASHI, Okazaki-shi, Aichi-ken (JP); Yoshinori SHIBATA, Nagoya-shi, Aichi-ken (JP); Keisuke UCHIDA, Nagoya-shi, Aichi-ken (JP); Hiromasa MIYOSHI, Okayama-shi, Okayama-ken (JP); Keiichi ENDOH, Okayama-shi, Okayama-ken (JP); Satoru KURITA, Okayama-shi, Okayama-ken (JP); Minami NAGAOKA, Okayama-shi, Okayama-ken (JP)

(73) Assignee: TOYOTA JIDOSHA KABUSHIKI KAISHA, Toyota-shi, Aichi-ken (JP)

(21) Appl. No.: 14/891,473

(22) PCT Filed: May 15, 2014
(86) PCT No.: PCT/IB2014/000736

§ 371 Date: Nov. 16, 2015

(30) Foreign Application Priority Data
May 17, 2013 (JP) 2013-104848

(51) Int. Cl. B23K 35/30; B23K 35/362; B23K 1/00; B23K 35/02

(52) U.S. Cl. CPC B23K 35/3006; B23K 35/025; B23K 35/362; B23K 1/0006

(57) ABSTRACT

A metal paste for joining includes aggregates of metal nanoparticles and a solvent, and an average particle size of the aggregates is 1 μm or more.

### BACKGROUND OF THE INVENTION

1. Field of the Invention

The present invention relates to a metal paste for joining, a joining method and a joined body.

2. Description of Related Art

A solder has been used as a joining material for joining members.

However, because of low melting point of the solder, it was difficult to use the solder in power device elements such as silicon carbide and gallium nitride of which operation temperatures are high. Therefore, at the present time, a metal paste containing metal nanoparticles having high heat resistance is used as a joining material.

For example, Japanese Patent Application Publication No. 2013-4309 (IP 2013-4309 A) discloses a metal nanoparticle paste containing metal nanoparticles, a phosphoric acid-based dispersant having a hydrophilic part, and a polar solvent. Further, International Publication No. WO 02/35554 discloses a conductive metal paste containing a varnish-like resin composition including an organic solvent, a metal filler having an average particle size of 0.5 to 20 μm, and metal ultrafine particles having an average particle size of 1 to 100 nm.

In a conventional metal paste, a lot of solvent was necessary to uniformly disperse the metal nanoparticles in the paste. However, when the solvent is present in the metal paste, there is a problem that even when the metal paste is coated on a member, dried and burned, joining strength of the member is not sufficient. This is because during drying and burning of the metal paste, the solvent is captured by a plurality of metal nanoparticles and remained in a joining part.

Further, even when members are joined under pressure to prevent the solvent from remaining in the joining part, there is a problem that a joining interface peels to degrade the joining strength.

### SUMMARY OF THE INVENTION

The present invention provides a metal paste capable of joining members with high strength, a joining method that uses the metal paste and a joined body joined with the metal paste.

The present inventors have found, after studying hard, that by the use of aggregates of metal nanoparticles, members can be joined with high strength. When a metal paste containing aggregates of metal nanoparticles is coated on a member, dried and burned, a plurality of aggregates gather and form voids between the aggregates. Since the solvent of the metal paste can evaporate through the formed voids, the remaining rate of the solvent in the joined part decreases and high joining strength can be achieved.

Such formation of the voids can be represented also as a shrinkage rate of the metal paste during drying and burning the metal paste. That is, when the metal paste is dried and burned, the metal paste shrinks since the solvent contained in the metal paste is removed. However, when voids are formed in the inside of the metal paste during drying and burning, the metal paste is apparently suppressed from shrinking. Therefore, when the metal paste having, small shrinkage rate during drying and burning is used, the remaining solvent becomes scarce, and the members can be joined with high strength.

A first aspect of the present invention relates to a metal paste for joining, which contains aggregates of metal nanoparticles and a solvent, the aggregates having an average particle size of 1 μM or more.

A content of the aggregates may be 5 to 50% by weight of the metal paste.

The metal paste may further contain metal particles having an average particle size of 0.3 to 3 μm.

A content of the metal particles may be 60 to 90% by weight of the metal paste.

A content of a metal component may be 90% by weight or more of a weight of the metal paste.

The content of the metal component may be 95% by weight or more of the weight of the metal paste.

A second aspect of the present invention relates to a metal paste for joining for joining members via a drying step and a burning step. In the drying step of drying at 120° C. for 30 minutes under an atmospheric pressure condition, the shrinkage rate of the metal paste in a thickness direction is 20% or less, and in the burning step of burning at 250° C. for 30 minutes under the atmospheric pressure condition, the shrinkage rate of the metal paste in the thickness direction is 10% or less.

A third aspect of the present invention relates to a metal paste for joining, in which in the drying step of drying at 120° C. for 30 minutes under an atmospheric pressure condition and in the burning step of burning at 250° C. for 30 minutes under the atmospheric pressure condition after the drying step described above, a total shrinkage rate of the metal paste in a thickness direction is 20% or less.

A fourth aspect of the present invention relates to a joining method, which includes a coating step of coating the metal paste according to the first aspect on a first member; and a joining step which includes a contact step of bringing the first member and a second member into contact, a drying step of drying the metal paste, and a burning step of burning the dried metal paste, the first member and the second member being joined by the drying step and the burning step.

The step of joining may be applied under a no-pressure condition.

A fifth aspect of the present invention relates to a joined body joined by the joining method described above.

According to the present invention, a metal paste capable of joining members with high strength can be provided.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 shows a schematic view of a test piece used in a joining strength test, a left drawing therein is a view of the test piece seen from a side and a right drawing therein is a view of the test piece seen from above;

FIG. 2 shows a schematic diagram of a joining strength test;

FIG. 3 shows simultaneous measurement data of differential thermal analysis and thermogravimetric measurement;

FIG. 4 shows a part of a cut surface of a test piece joined with a metal paste for joining according to an embodiment of the present invention; and

FIG. 5 shows a part of a cut surface of the test piece that is joined with the metal paste of Comparative Example, a right drawing therein is a diagram obtained by enlarging a joining interface of the left drawing.

### DETAILED DESCRIPTION OF EMBODIMENTS

<Metal Paste for Joining> An embodiment of the present invention relates to a metal paste for joining, which includes aggregates of metal nanoparticles and a solvent, and an average particle size of the aggregates is 1 μm or more. Since the aggregates of the metal nanoparticles are present in the metal paste, when the metal paste is coated on a member, dried and burned, a plurality of aggregates gathers and forms voids between the aggregates. Through the formed voids, the solvent of the metal paste can evaporate, therefore the remaining rate of the solvent in the joining part can be reduced. Further, by forming voids in the joining part, the joining part becomes a porous structure, obtains excellent stress relaxation property and can join the member with high strength.

In a conventional metal paste, various measures have been applied such that aggregates of the metal nanoparticles may not be formed. However, in the present embodiment, an extraordinary effect such that, by venturing to use the aggregates, the joining strength is improved can be exhibited.

The aggregate of the metal nanoparticles is a secondary particle in which primary particles of the metal nanoparticles aggregated. An average particle size of the aggregates is 1 μm or more, preferably 1 to 5 μm, more preferably 1 to 3 μm and particularly preferably 1 to 2 μm. When the aggregates having such an average particle size are used, the joining strength of the member can further be improved.

“An average particle size of aggregates” in the present specification can be determined based on particle sizes of randomly selected 100 aggregates by observing the metal paste for joining with a scanning electron microscope (SEM), in particular, with a Cryo-SEM. Specifically, the average particle size of aggregates can be determined in such a manner that particle sizes of the selected 100 aggregates are measured, 10 aggregates having the largest particle size and 10 aggregates having the smallest particle size are removed, and a sum total of particle sizes of 80 aggregates is divided by 80. “The particle size of aggregates” means an equivalent circular diameter. Specifically, an area of individual aggregates is measured and a diameter of a circle having the same area as the measured area is taken as a diameter of the aggregate.

In the case of not being pasty but being particulate, D50 can be calculated with a laser diffraction particle size analyzer. For example, a particle size distribution is measured by directly charging a powder in a HELOS & RODOS (manufactured by Japan Laser Corp.) that is a laser diffraction type particle size analyzer, a value of D50 of the obtained particle size distribution is taken as “an average particle size of the aggregates”.

An average particle size of primary particles that form aggregates that are secondary particles is preferably 1 to 100 nm, more preferably 5 to 70 nm, and particularly preferably 10 to 40 nm. When the aggregates formed of the primary particles having such average particle size are used, the joining strength of the member can further be improved. “An average particle size of primary particles” can be calculated from a SEM photograph.

A content of the aggregates is preferably 5 to 50% by weight, more preferably 10 to 40% by weight, and particularly preferably 15 to 30% by weight of a weight of the metal paste. When the aggregates are present at such a content, the joining strength of the member can further be improved.

A surface of the aggregate is preferable to be coated with an organic compound. Presence of a coat on a surface of the aggregate can prevent the metal nanoparticles from excessively aggregating in the metal paste. Although a kind of the organic compound is not limited to particular one, an organic compound having 8 or less carbons is preferable. Since the organic compound having 8 or less carbons can be removed at a low temperature, the members can be joined at a low temperature.

The organic compounds having 8 or less carbon atoms include C1 to C8 carboxylic acid, dicarboxylic acid, and unsaturated fatty acids, for example. More specifically, octanoic acid, heptanoic acid, hexanoic acid, pentanoic acid, butanoic acid, propanoic acid, oxalic acid, malonic acid, ethyl malonic acid, succinic acid, methyl succinic acid, glutaric acid, adipic acid, pimelic acid, suberic acid, sorbic acid and maleic acid can be used.

The metal paste containing the aggregates can be prepared by mixing aggregates prepared in advance with a solvent. Aggregates having a specified average particle size can be prepared by means of a known method. For example, when a drying temperature and a drying time are set to a proper condition in a step of drying nanoparticles recovered in particle synthesis, aggregates having a specified average particle size can be prepared.

A kind of metal of the metal nanoparticles that form the aggregates is not particularly limited as long as it can be used to join members. Either one of a noble metal and a base metal can be used. Examples of the noble metals include silver, gold, ruthenium, rhodium, palladium, iridium and platinum. Examples of the base metals include copper, aluminum, iron, and nickel. The aggregates of one kind of metal nanoparticles may be used and the aggregates of two or more kinds of metal nanoparticles may be used. Although there is no particular limitation, the aggregates of silver nanoparticles can preferably be used.

The metal paste for joining according to an embodiment of the present invention is preferable to contain another metal particles (hereinafter, referred to as “metal filler”) in addition to the aggregates of the metal nanoparticles described above. As the metal filler, metal particles having an average particle size of primary particles of 0.3 to 3 preferably 0.5 to 2 μm, and still more preferably 0.6 to 1 μm are preferably used. When the metal paste for joining contains such metal filler, the joining strength of the member can further be improved. The “average particle size of the metal filler” can be determined in the same manner as that of “average particle size of the aggregates”.

A content of the metal filler is preferably 60 to 90% by weight, more preferably 65 to 85% by weight, and particularly preferably 70 to 80% by weight of a weight of the metal paste. When the metal filler is contained at such a content, the joining strength of the member can further be improved.

As a kind of the metal of the metal filler, the same one as that of the metal nanoparticles that form the aggregates can be used. Although it is not limited to particular one, the metal filler and the metal nanoparticles are preferably the same kind of metal, and silver is particularly preferable.

Since the aggregates of the metal nanoparticles have a smaller specific surface area compared with that of the same amount of the metal nanoparticles that are not aggregated, the viscosity of the metal paste containing the aggregates of the metal nanoparticles is relatively low. Therefore, the fluidity of the metal paste for joining according to the embodiment of the present invention is high and handling thereof is easy.

Further, since the viscosity of the metal paste is low, the content of the metal component can further be increased.

For example, a sum total of contents of the metal components contained in the metal paste for joining can be set preferably to 90% by weight or more, more preferably to 92% by weight or more, still more preferably to 94% by weight or more and particularly preferably to 95% by weight or more of a weight of the metal paste. Although the upper limit of the sum total of the metal components is not particularly limited as long as it is less than 100% by weight, for example, it can be set to 99% by weight, or 98% by weight, for example. Even when the metal component is contained at the content like this, the metal paste can be easily handled because of high fluidity.

Further, when the content of the metal component is increased, the joining strength of the member can further be improved.

The metal paste for joining according to the embodiment of the present invention includes a solvent for dispersing the metal component. Although the kind of the solvent is not limited to particular one, for example, protonic polar solvents such as water and alcohols; nonprotonic polar solvents such as amide (dimethyl acetamide, for example), nitrile (acetonitrile, for example), ketone (acetone, for example), and cyclic ether (tetrahydrofuran, for example) can be used. Although it is not limited to particular one, alcohols (C₁₋₁₈ alcohols, for example) can preferably be used, more specifically, butanol, pentanol, hexanol, heptanol, octanol, isobornyl cyclohexanol, terpineol, octanediole, decanol, nonanol, and undecanol can preferably be used.

A content of the solvent is preferably 1 to 7% by weight, more preferably 2 to 6% by weight and particularly preferably 3 to 5% by weight of a weight of the metal paste. Since the specific surface area of the aggregates of the metal nanoparticles is small as described above, even when the content of the solvent is reduced, the fluidity of the metal paste can be maintained. Further, by reducing the content of the solvent, the content of the metal component can relatively be increased.

The metal paste for joining according to the embodiment of the present invention may further include a dispersant for dispersing the metal component. Although a kind of the dispersant is not limited to particular one, for example, a phosphoric acid-based dispersant can be used.

The phosphoric acid-based dispersant preferably has a phosphoric acid group and a hydrophilic part. For example, a phosphoric acid ester-based dispersant, a polyoxyalkylene alkyl ether phosphoric acid-based dispersant, and a polyoxyalkylene alkyl phenyl ether phosphoric acid-based dispersant can be used. The phosphoric acid group may be a salt form. As the hydrophilic part, for example, polyalkylene glycol (polyethylene glycol, polytetraethylene glycol, and polypropylene glycol), and polyglycerin can be used. Though not limited to particular one, it is preferable to have polyethylene glycol as the hydrophilic group.

Further, also a phosphoric acid-based dispersant having the following structure can be used.

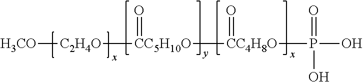

In a formula, x is an integer of 6 to 20 (preferably an integer of 6 to 14), y is an integer of 0 to 5 (preferably an integer of 0 to 2), z is an integer of 0 to 5 (preferably an integer of 0 to 2), and x+y+z is an integer of 6 to 30 (preferably an integer of 6 to 18).

A content of the dispersant is preferably 0.1 to 2.5% by weight, more preferably 0.3 to 2% by weight, and particularly preferably 0.5 to 1.5% by weight of a weight of the metal paste.

The metal paste for joining according to the embodiment of the present invention can maintain the viscosity at a low level while containing the metal component at a high ratio. For example, the viscosity of the metal paste is 40 to 100 Pa·s, preferably 50 to 90 Pa·s, and more preferably 60 to 80 Pa·s. The viscosity can be measured according to a method described in the following example.

The metal paste for joining according to the embodiment of the present invention can be represented also by a shrinkage rate of the metal paste when the metal paste is dried and burned. That is, the embodiment of the present invention relates also to a metal paste for joining in which in the drying step of drying at 120° C. for 30 minutes under an atmospheric pressure condition, the shrinkage rate of the metal paste for joining in a thickness direction is 20% or less, and in the burning step of burning at 250° C. for 30 minutes under an atmospheric pressure condition, the shrinkage, rate of the metal paste for joining in a thickness direction after the drying step described above is 10% or less.

The shrinkage rates of the metal paste can be determined based on changes of the thickness by measuring thicknesses of the metal paste before and after the drying step, and thicknesses of the metal paste after the burning step. Specifically, a metal mask (opening: 10 mm×10 mm, thickness: 110 μm) is applied on a copper substrate (thickness: 1 mm), and a metal paste is coated thereon. After that, a thickness of the coated metal paste is measured with a laser microscope. Then, a hot-plate is used to dry the metal paste at 120° C. for 30 minutes under atmospheric pressure, and a thickness of the metal paste after drying is measured with a laser microscope. Further, the hot-plate is used to burn the dried metal paste at 250° C. for 30 minutes under atmospheric pressure, and a thickness of the metal paste after burning is measured with a laser microscope. From measured thicknesses of the metal paste, the shrinkage rate in the drying step and the shrinkage rate in the burning step can be determined.

The shrinkage rate of the metal paste in the drying step is 20% or less, preferably 18% or less, more preferably 16% or less and particularly preferably 14% or less. Although there is no particular lower limit of the shrinkage rate in the drying step, 1%, 5%, 10%, for example, can be used.

The shrinkage rate of the metal paste in the burning step is 10% or less, preferably 8% or less, more preferably 6% or less and particularly preferably 4% or less. Although there is no particular lower limit of the shrinkage rate in the burning step, 0.01%, 0.04%, 0.08%, for example, can be used.

The shrinkage rate of the metal paste may be represented as a total shrinkage rate in the drying step and the burning step. In this case, the total shrinkage rate of the metal paste for joining according to the embodiment of the present invention is 20% or less, preferably 18% or less, and more preferably 16% or less.

<Joining Method and Joined Body> An embodiment of the present invention relates to a joining method that includes: a step of coating the metal paste for joining at least on a first member; and a step of bringing the first member and the second member into contact and drying and burning to join the first member and the second member, and also to a joined body joined by the joining method described above. The metal paste for joining according to the embodiment of the present invention can sufficiently remove the solvent in the metal paste and can form a porous structure having excellent stress relaxation property, therefore the members can be joined with high strength.

A kind of the members to be joined is not limited to particular one, and a metal material, a plastic material, and a ceramic material can be used. As the metal material, for example, a copper substrate, a gold substrate, and an aluminum substrate can be used. As the plastic material, for example, polyimide, polyethylene, polypropylene, polyethylene terephthalate, polycarbonate, and polyethylene naphthalate can be used. As the ceramic material, for example, glass and silicon can be used. Further, an electronic element can be used as the member. In particular, when the metal paste contains a refractory metal component, power device elements such as silicon carbide and gallium nitride can be used as the member.

The first member and the second member may be the members of the same kind or may be the members of different kinds.

An amount of the metal paste coated in the step of coating is not particularly limited and can be properly adjusted according to a magnitude and a kind of the members to be joined.

In the step of joining, the metal paste coated on the first member and the second member are brought into contact, dried and burned, thus the first member and the second member can be joined. According to the joining method of the embodiment of the present invention, the step of joining can be performed also under no-pressure condition. The “no-pressure condition” means that there is no need of applying high pressure by means of a machine, and a pressure to an extent of applying with a human hand is not eliminated. When the members are joined under no-pressure condition, a production cost of the joined body can largely be reduced.

A drying condition of the metal paste in the step of joining can be appropriately changed corresponding to an amount and a composition of the metal paste. For example, conditions of 80 to 160° C. and 100 to 140° C. under an atmospheric pressure, a N₂ atmosphere, a vacuum, or a reducing atmosphere can be used. Further, also the burning condition can properly be changed, for example, conditions of 200 to 300° C. and 220 to 270° C. under an atmospheric pressure, a N₂ atmosphere, a vacuum, or a reducing atmosphere can be used.

Hereinafter, the present invention will be described in more detail with reference to examples. However, the technical range of the present invention is not limited thereto.

<Preparation of Aggregates of Silver Nanoparticles> Aggregates of silver nanoparticles commonly used in the present examples are prepared as shown below. As a reaction bath, a 5 L reaction bath was used. A stirring bar with a stirring blade was placed in the reaction bath at a center thereof A thermometer for monitoring a temperature is installed to the reaction bath, and a nozzle is installed to be able to supply nitrogen from a lower portion to a solution.

Firstly, 3400 g of water was charged into the reaction bath, and nitrogen was flowed at a flow rate of 3000 mL/minute for 600 seconds from a lower portion of the reaction bath to remove remaining oxygen. Thereafter, nitrogen was supplied at a flow rate of 3000 mL/minute from an upper portion of the reaction bath and the inside of the reaction bath was changed to a nitrogen atmosphere. Then, a temperature control was performed while stirring such that a solution temperature in the reaction bath may be 60° C. Next, 7 g of ammonia water containing 28% by mass of ammonia was charged into the reaction bath, followed by stirring for 1 minute to make the liquid homogeneous.,

Next, 45.5 g (corresponding to 1.98 by a molar ratio relative to silver) of hexanoic acid (manufactured by Wako Pure Chemical Industries, Ltd.) was added as a protective agent and stirred for 4 minutes to dissolve the protective agent. Thereafter, 23.9 g (corresponding to 4.82 equivalent relative to silver) of an aqueous solution of 50% by mass of hydrazine hydrate (manufactured by Otsuka Chemical Co. Ltd.) was added as a reducing agent and this was used as a reducing agent solution.

A aqueous solution of silver nitrate in which 33.8 g of silver nitrate crystal (manufactured by Wako Pure Chemical Industries, Ltd.) was dissolved in water of 180 g was prepared in a separate vessel, and this was used as an aqueous solution of silver salt. In the aqueous solution of silver salt, an amount to be 0.00008 g (corresponding to 1 ppm relative to silver in terms of copper) of copper nitrate trihydrate (manufactured by Wako Pure Chemical Industries, Ltd.) was added. Since this is an amount that cannot be measured with a generally available measuring balance, copper nitrate trihydrate was added in such a manner that an aqueous solution containing copper nitrate trihydrate at a certain degree higher concentration was prepared, this was diluted, and the diluted solution was added such that a target amount of copper may be added. Further, the aqueous solution of silver salt was temperature-controlled to 60° C. the same as the reducing agent solution in the reaction bath.

Thereafter, the aqueous solution of silver salt was added at once into the reducing agent solution to mix and a reducing reaction was started thereby. At that time, a change in a color of the slurry calmed down within about 10 seconds after the start of the reducing reaction. The stirring was continued and the solution was aged as it is for 10 minutes. Thereafter, the stirring was stopped, via solid-liquid separation by the suction filtering, cleansing with pure water, and drying at 40° C. for 12 hours, a fine silver particle powder was obtained. A silver content in the powder at this time was calculated as 97% by mass from confirmation test of a remaining amount by heating. The balance is considered to be made of hexanoic acid or a derivative thereof.

The obtained silver nanoparticles were in a form of aggregates. A particle size of the aggregates was measured with a HELOS D50. Specifically, a powder was directly charged into a HELOS & RODOS (manufactured by Nippon Laser Corp.) to measure a particle size distribution, and a value of D50 of the resulted particle size distribution was taken as “a particle size of the aggregates”.

A particle size of primary particles was obtained in such a manner that a scanning electron microscope was used to take a photograph at a magnification of 80000 times, and from the obtained photograph a particle size was calculated with an image soft. An average primary particle size at this time was obtained by measuring at least 200 particles of individually independent particles in a SEM photograph and by averaging particle sizes thereof.

<Preparation of Metal Paste for Joining> Comparative metal paste V and metal pastes A to C having a composition shown in Table 1 were prepared. The comparative metal paste V was obtained in such a manner that, after mixing various components, the mixture was treated with a three roller mill (roll gap: 1 μm) to disperse all of the aggregates. The metal paste A was prepared in such a manner that a mixture of aggregates of silver nanoparticles (10% by weight) and other components was treated with the three roller mill and aggregates of silver nanoparticles (9% by weight) were added thereto. The metal pastes B and C were not treated with the three roller mill.

TABLE 1

| | Comparative | | | |
|---|---|---|---|---|
| | metal | Metal | Metal | Metal |
| | paste V | paste A | paste B | paste C |
| Silver | 19 wt %*4 | 19 wt %*5 | 50 wt % | 55 wt % |
| nanoparticle | | | | |
| aggregate*1 | | | | |
| (average | | | | |
| particle | | | | |
| size: 1.8 μm) | | | | |
| Silver filler | 76 wt % | 76 wt % | 45 wt % | 40 wt % |
| (average | | | | |
| particle | | | | |
| size: 0.8 μm) | | | | |
| 1-octanol | 2.5 wt % | 2.5 wt % | 2.5 wt % | 2.5 wt % |
| MTPH*2 | 1.5 wt % | 1.5 wt % | 1.5 wt % | 1.5 wt % |
| (manufactured | | | | |
| by Nippon | | | | |
| Terpene | | | | |
| Chemicals, | | | | |
| Inc.) | | | | |
| Phosphoric | 1 wt % | 1 wt % | 1 wt % | 1 wt % |
| acid-based | | | | |
| Dispersant*3 | | | | |

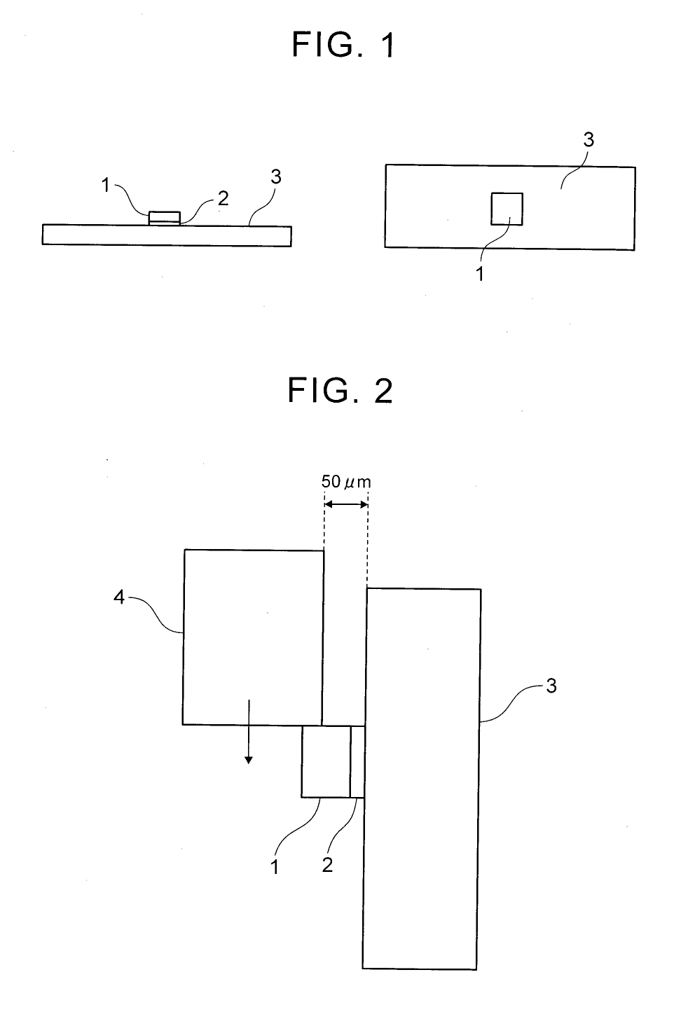

*1average primary particle size: 20 nm
*2Isobornylcyclohexanol
*3DISPER-BYK 111 manufactured by BYK Chemie (containing a phosphoric acid-based dispersant represented by the chemical formula described above)
*4All were treated with a three roller mill
*510 wt % was treated with a three roller mill

<Joining Strength Test> As shown in FIG. 1, each of the metal pastes 2 prepared above (20 mg) was coated on a copper substrate 1 of 3 mm×3 mm (thickness: 0.5 mm), and this was stuck onto a copper substrate 3 of 50 mm×10 mm (thickness: 1 mm) (FIG. 1). This was dried at 120° C. for 10,minutes in a N₂ atmosphere, then burned at 270° C. for 30 minutes in a N₂ atmosphere, and a test piece was obtained.

### (1) Initial Shearing Strength

The shearing strength of the test piece was measured using a push pull gauge RX-100 (manufactured by Aikoh Engineering, Co., Ltd.) (FIG. 2).

(2) Shearing Strength after Thermal Shock Treatment (−55° C./150° C.)

The test piece was held under a temperature condition of −55° C. for 10 minutes, immediate thereafter the test piece was transferred to a temperature condition of 150° C. and held there for 10 minutes. With the treatment as one cycle, the treatment was repeated by 1000 cycles. Thereafter, the shearing strength of the test piece was measured in the same manner as the (1) described above.

(3) Shearing Strength after Thermal Shock Treatment (−40° C./250° C.)

The test piece was held under a temperature condition of −40° C. for 10 minutes, immediate thereafter the test piece was transferred to a temperature condition of 250° C. and held there for 10 minutes. With the treatment as one cycle, the treatment was repeated by 1001 cycles. Thereafter, the shearing strength of the test piece was measured in the same manner as the (1) described above. Results are shown in Table 2.

TABLE 2

| | Comparative | Metal | Metal | Metal |
|---|---|---|---|---|
| | Metal Paste V | Paste A | Paste B | Paste C |
| Initial shearing | Good | Good | Good | Good |
| strength | (65 MPa) | (83 MPa) | (32 MPa) | (25 MPa) |
| Thermal shock | Good | Good | Good | Good |
| treatment | | | | |
| (−55° C./150° C.) | | | | |
| shearing | | | | |
| strength | | | | |
| Thermal shock | Poor | Good | Good | Poor |
| treatment | | | | |
| (−40° C./250° C.) | | | | |
| shearing | | | | |
| strength | | | | |

Good: 20 MPa or more,
Poor: less than 20 MPa

<Shrinkage Rate Measurement Test> A metal mask (opening: 10 mm×10 mm, thickness: 110 μm) was placed on a copper substrate (thickness: 1 mm), each of the metal pastes prepared above was coated thereon, and a thickness of the metal paste was measured with a laser microscope.

Then, the metal paste was dried with a hot-plate at 120° C. for 30 minutes under atmospheric pressure, and a thickness of the dried metal paste was measured with the laser microscope.

Further, the dried metal paste was burned at 250° C. for 30 minutes under atmospheric pressure with the hot-plate, and a thickness of the burned metal paste was measured with the laser microscope. Results are shown in Table 3.

TABLE 3

| | Comparative | | | | | | | |
|---|---|---|---|---|---|---|---|---|
| | Metal Paste V | | Metal Paste A | | Metal Paste B | | Metal Paste C | |
| | Film | | Film | | Film | | Film | |
| | thickness | Shrinkage | thickness | Shrinkage | thickness | Shrinkage | thickness | Shrinkage |
| | (μm) | rate (%) | (μm) | rate (%) | (μm) | rate (%) | (μm) | rate (%) |
| Coated | 83.5 | — | 71.7 | — | 86.2 | — | 75.2 | — |
| film | | | | | | | | |
| Dried | 53.3 | 36.1 | 61.9 | 13.6 | 69.3 | 19.6 | 58.8 | 21.8 |
| film | | | | | | | | |
| Burned | 48.6 | 8.8 | 60.9 | 3 | 69.3 | 0.1 | 58.6 | 0.2 |
| film | | | | | | | | |
| | Total | | Total | | Total | | Total | |
| | shrinkage | | shrinkage | | shrinkage | | shrinkage | |
| | rate 41.7% | | rate 15.0% | | rate 19.6% | | rate 22.0% | |

Still further, a cross section of the burned metal paste was observed with a

SEM (magnification: 200 times), and a content of a porous portion in an entire cross section was measured. Specifically, the cross section of a joined portion was digitized with an image processing soft (product name: PHOTOSHOP), and a portion having voids of 50% or more per unit area was taken. as a porous portion. Results are shown in Table 4.

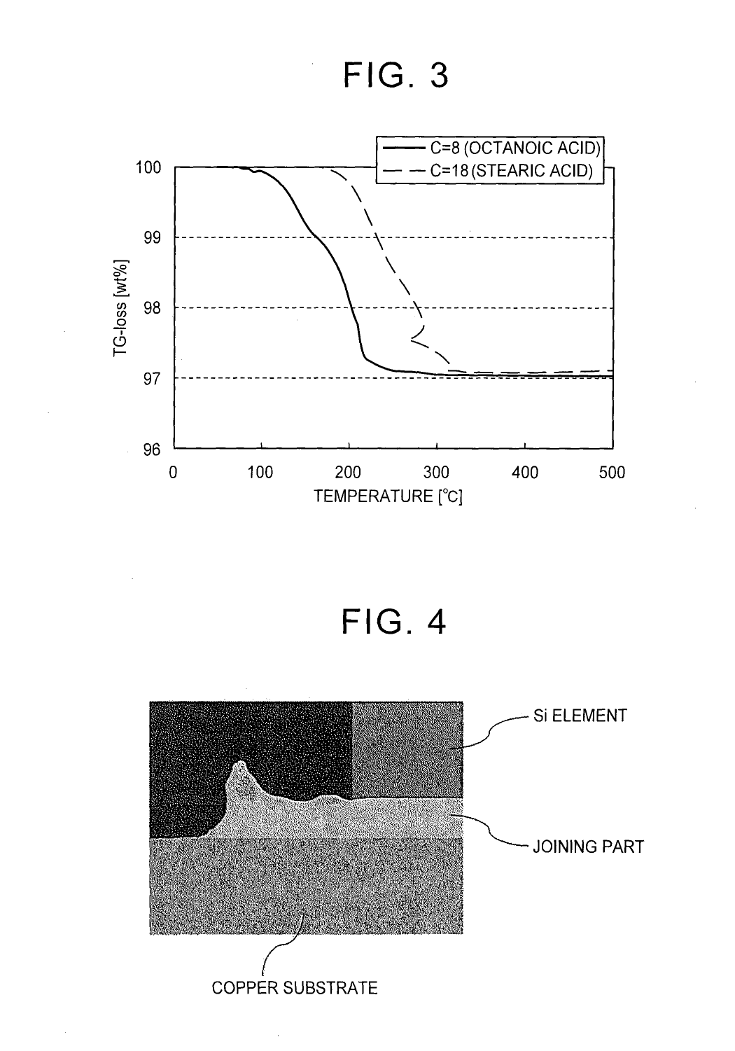

TABLE 4

| | Comparative | | Metal | |
|---|---|---|---|---|
| | metal paste V | Metal paste A | paste B | Metal paste C |
| Content of | 0 | 5 | 47 | 53 |
| porous | | | | |
| portion (%) | | | | |

<Study of Organic Coating> Silver nanoparticles coated with octanoic acid (number of carbon atoms: 8) and silver particles coated with stearic acid (number of carbon atoms: 18) were subjected to a simultaneous measurement of differential thermal analysis and thermogravimetric measurement (TG-DTA). Results are shown in FIG. 3.

As obvious from the results of FIG. 3, octanoic acid could be removed at a lower temperature than that of stearic acid.

<Comparison Test 1> A metal paste D and a comparative metal paste W having a composition shown in Table 5 were prepared. The comparative metal paste W was, after mixing various components, treated with the three roller mill (roll gap: 1 μm) and all of the aggregates were dispersed.

(1) The viscosity of each of the metal pastes was measured with a rheometer. (RheoStress 600, manufactured by Haake Corp.) under condition of 25° C., cone) (35/2°, 5 rpm, and a shear rate: 15.7 (1/s). The viscosity of the metal paste D was 68.9 Pa·s. On the other hand, the viscosity of the comparative metal paste W could not be measured because it could not be pasty.

(2) A metal mask (opening: 7.6 mm×7.6 mm, thickness: 120 μm) was placed on each of 50 mm×10 mm (thickness: 1 mm) copper substrates, each of the metal pastes prepared above (0.042 g) was coated. A Si element of 7.6 mm×7.6 mm (thickness: 0.45 mm) was placed on each of the metal pastes, and this was pressed such that a thickness of the coating may be 100 μm. This was dried at 80° C. for 10 minutes, at 100° C. for 10 minutes, at 140° C. for 10 minutes and at 180° C. for 10 minutes in a N₂ atmosphere, then burned at 270° C. for 30 minutes in a N₂ atmosphere, thus a test piece was obtained.

A joining part of each of test pieces was photographed with an ultrasonic microscope (C-SAMD-9500, manufactured by Sonoscan Inc.), after digitizing with an image processing soft (product name: Photoshop), a joining area rate was determined. As a result, when an area of the Si element is set to 100%, the joining area rate when the metal paste D was used was 96%, and the joining area rate when the comparative metal paste W was used was 62.9%.

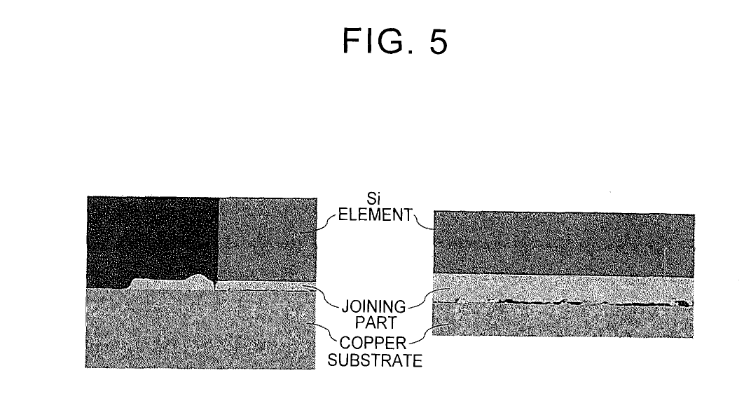

A cut surface of the test piece that uses the metal paste D is shown in FIG. 4, and a cut surface of the test piece that uses the comparative metal paste W is shown in FIG. 5. While the copper substrate and the Si element were excellently joined in FIG. 4, a joining interface was peeled in FIG. 5.

TABLE 5

| | Metal | Comparative |
|---|---|---|
| | paste D | metal paste W |
| Silver nanoparticle aggregate*¹ | 19 wt % | 19 wt % |
| (average particle size: 1.8 μm) | | |
| Silver filler | 76 wt % | 76 wt % |
| (average particle size: 0.8 μm) | | |
| 1-octanol | 2.5 wt % | 2.5 wt % |
| MTPH*² | 1.5 wt % | 1.5 wt % |
| (manufactured by Nippon Terpene Corp.) | | |
| Phosphoric acid-based dispersant*³ | 1 wt % | 1 wt % |
| Viscosity | 68.9 Pa · s | — |
| Joining area rate | 96% | 62.9% |

*¹Average primary particle diameter 20 nm
*²Isobornylcyclohexanol
*³DISPER-BYK 111 manufactured by BYK Chemie

<Comparison Test 2> A metal paste E and a comparative metal paste X having a composition shown in Table 6 were prepared. The comparative metal paste X was, after mixing various components, treated with the three roller mill (roll gap: 1 μm) and all of the aggregates were dispersed.

A metal mask (opening: 7.6 mm×7.6 mm, thickness: 120 μm) was placed on each of 50 mm×10 mm (thickness: 1 mm) copper substrates, each of the metal pastes prepared above (0.042 g) was coated. A Si element of 7.6 mm×7.6 mm (thickness: 0.45 mm) was placed on each of the metal pastes, and this was pressed such that a thickness of the coating may be 100 μM. This was dried at 80° C. for 10 minutes, at 100° C. for 10 minutes, at 140° C. for 10 minutes and at 180° C. for 10 minutes in a N₂ atmosphere, then burned at 270° C. for 30 minutes in a N₂ atmosphere, thus a test piece was obtained.

### (1) Initial Joining Area Rate

A joining part of each of test pieces was photographed with an ultrasonic microscope (C-SAMD-9500, manufactured by Sonoscan Inc.), after digitizing with the Photoshop, a joining area rate was determined. Results are shown in Table 6. An area of the Si element was set to 100%.

(2) Joining Area Rate after Thermal Shock Test (−65° C./170° C., 250 cycles)

The test piece was held under a temperature condition of −65° C. for 10 minutes, immediate thereafter the test piece was transferred to a temperature condition of 170° C. and held there for 10 minutes. With the treatment as one cycle, the treatment was repeated by 250 cycles. Thereafter, the joining area rate of the test piece was measured in the same manner as the (1) described above.

(3) Joining Area Rate after Thermal Shock Test (−65° C./170° C., 500 cycles) The test piece was held under a temperature condition of −65° C. for 10 minutes, immediate thereafter the test piece was transferred to a temperature condition of 170° C. and held there for 10 minutes. With the treatment as one cycle, the treatment was repeated by 500 cycles. Thereafter, the joining area rate of the test piece was measured in the same manner as the (1) described above.

TABLE 6

| | Metal | Comparative |
|---|---|---|
| | paste E | metal paste X |
| Silver nanoparticle aggregate*¹ | 19 wt % | 19 wt % |
| (average particle size: 1.8 μm) | | |
| Silver filler | 76 wt % | 76 wt % |
| (average particle size: 0.8 μm) | | |
| 1-octanol | 2.5 wt % | 2.5 wt % |
| MTPH*² | 1.5 wt % | 1.5 wt % |
| (manufactured by Nippon Terpene Corp.) | | |
| Phosphoric acid-based dispersant*³ | 1 wt % | 1 wt % |
| Initial joining area rate | 94.2% | 85.4% |
| Joining area rate after thermal shock test | 93.4% | 13.3% |
| (−65° C./170° C.) 250 cycles | | |
| Joining area rate after thermal shock test | 88.2% | 7.0% |
| (−65° C./170° C.) 500 cycles | | |

*¹Average primary particle diameter 20 nm
*²Isobomylcyclohexanol
*³DISPER-BYK 111 manufactured by BYK Chemie

<Comparison Test 3> Metal pastes F and G and Comparative metal pastes

Y and Z having a composition shown in Table 7 and the almost same viscosity were prepared. As to comparative metal pastes Y and Z, after mixing various components, the mixture was treated with the three roller mill (roll gap: 1 μm), and all of the aggregates was dispersed. The, metal pastes F and G had the same components and also the comparative metal pastes Y and Z had the same components, these were prepared to perform n=2 experiment's.

A metal mask (opening: 7.6 mm×7.6 mm, thickness: 120 μm) was placed on each of 50 mm×10 mm (thickness: 1 mm) copper substrates, each of the metal pastes prepared above (0.041 g) was coated thereon. A Si element of 7.6 mm×7.6 mm (thickness: 0.45 mm) was placed on each of the metal pastes, and this was pressed such that a thickness of the coating may be 100 μm. This was dried at 80° C. for 10 minutes, at 100° C. for 10 minutes, at 140° C. for 10 minutes and at 180° C. for 10 minutes in a N₂ atmosphere, then burned at 270° C. for 30 minutes in a N₂ atmosphere, thus a test piece was obtained.

A joining part of each of test pieces was photographed with an ultrasonic microscope (C-SAMD-9500, manufactured by Sonoscan Inc.), after digitizing with the Photoshop, a joining area rate was determined. Results are shown in Table 7. An area of the Si element was set to 100%.

TABLE 7

| | Metal | Metal | Comparative | Comparative |
|---|---|---|---|---|
| | paste F | paste G | metal paste Y | metal paste Z |
| Silver nanoparticle aggregate*¹ | 19 wt % | 19 wt % | 18 wt % | 18 wt % |
| (average particle size: 1.8 μm) | | | | |
| Silver filler | 76 wt % | 76 wt % | 74 wt % | 74 wt % |
| (average particle size: 0.8 μm) | | | | |
| 1-octanol | 2.5 wt % | 2.5 wt % | 4 wt % | 4 wt % |
| MTPH*² | 1.5 wt % | 1.5 wt % | 3 wt % | 3 wt % |
| (manufactured by Nippon | | | | |
| Terpene Corp.) | | | | |
| Phosphoric acid-based | 1 wt % | 1 wt % | 1 wt % | 1 wt % |
| dispersant*³ | | | | |
| Viscosity | 68.9 Pa · s | 68.9 Pa · s | 70.1 Pa · s | 70.1 Pa · s |
| Joining area rate | 95.2% | 94.2% | 67.8% | 72.9% |

*¹Average primary particle diameter 20 nm
*²Isobornylcyclohexanol
*³DISPER-BYK 111 manufactured by BYK Chemie

1. A metal paste for joining, the metal paste comprising:
aggregates of metal nanoparticles; and
a solvent,
wherein an average particle size of the aggregates is 1 μm or more, and
a content of the aggregates is 5 to 50% by weight of a weight of the metal paste.

2. (canceled)

3. The metal paste according to claim 1, further comprising:
metal particles having an average particle size of 0.3 to 3 μm.

4. The metal paste according to claim 3, wherein a content of the metal particles is 60 to 90% by weight of a-the weight of the metal paste.

5. The metal paste according to claim 3, wherein a content of a metal component including a metal in the metal nanoparticles and the metal particles is 90% by weight or more of the weight of the metal paste.

6. The metal paste according to claim 5, wherein the content of the metal component is 95% by weight or more of the metal paste.

7. A metal paste for joining for joining members through a drying step and a burning step, wherein a shrinkage rate of the metal paste in a thickness direction is 20% or less in the drying step of drying at 120° C. for 30 minutes under an atmospheric pressure condition, and the shrinkage rate of the metal paste after the drying step in the thickness direction is 10% or less in the burning step of burning at 250° C. for 30 minutes under the atmospheric pressure condition.

8. A metal paste for joining, wherein a total shrinkage rate of the metal paste in a thickness direction is 20% or less in a drying step of drying at 120° C. for 30 minutes under an atmospheric pressure condition and in a burning step of burning at 250° C. for 30 minutes under the atmospheric pressure condition after the drying step.

9. A joining method, comprising:
a coating step of coating the metal paste according to claim 1 on a first member; and
a joining step of joining the first member and a second member, the joining step including a contact step of bringing the first member and the second member into contact, a drying step of drying the metal paste, and a burning step of burning the dried metal paste, the first member and the second member being joined by the drying step and the burning step.

10. The joining method according to claim 9, wherein the joining step is performed under no-pressure condition.

11. A joined body joined according to the method according to claim 9.

12. A metal paste for the joining method according claim 9, wherein a shrinkage rate of the metal paste in a thickness direction is 20% or less in the drying step of drying at 120° C. for 30 minutes under an atmospheric pressure condition, and a shrinkage rate of the metal paste after the drying step in the thickness direction is 10% or less in the burning step of burning at 250° C. for 30 minutes under the atmospheric pressure condition.

13. A metal paste for the joining method according claim 9, wherein a total shrinkage rate of the metal paste in a thickness direction is 20% or less in the drying step of drying at 120° C. for 30 minutes under an atmospheric pressure condition and in the burning step of burning at 250° C. for 30 minutes under the atmospheric pressure condition after the drying step.
